(19) United States
(12) Patent Application Publication
(10) Pub. No.: US 2023/0138094 A1
(43) Pub. Date: May 4, 2023

(54) OPPORTUNISTIC MEMORY POOLS

(71) Applicant: Intel Corporation, Santa Clara, CA (US)

(72) Inventors: Francesc GUIM BERNAT, Barcelona (ES); Marcos E. CARRANZA, Portland, OR (US); Cesar Ignacio MARTINEZ SPESSOT, Hillsboro, OR (US); Kshitij A. DOSHI, Tempe, AZ (US); Ned SMITH, Beaverton, OR (US)

(21) Appl. No.: 18/090,255

(22) Filed: Dec. 28, 2022

(51) Int. Cl. G06F 3/06

(52) U.S. Cl. CPC G06F 3/0614; G06F 3/0644; G06F 3/0673

(57) ABSTRACT

Methods and apparatus for opportunistic memory pools. The memory architecture is extended with logic that divides and tracks the memory fragmentation in each of a plurality of smart devices in two virtual memory partitions: (1) the allocated-unused partition containing memory that is earmarked for (allocated to), but remained un-utilized by the actual workloads running, or, by the device itself (bit-streams, applications, etc.); and (2) the unallocated partition that collects unused memory ranges and pushes them in to an Opportunistic Memory Pool (OMP) which is exposed to the platform's memory controller and operating system. The two partitions of the OMP allow temporary utilization of otherwise unused memory. Under alternate configurations, the total amount of memory resources is presented as a monolithic resource or two monolithic memory resources (unallocated and allocated but unused) available for utilization by the devices and applications running in the platform.

### BACKGROUND OF THE INVENTION

Edge computing is a distributed computing paradigm which brings computation and data storage closer to the location where it is needed. This improves response times (latency), saves bandwidth, and improves reliability.

One of the challenges of current edge deployments is how to configure platforms deployed at the various edges of the network (from the access to the central office) for different type of workloads and uses cases (NFV (Network Function Virtualization), AR/VR, CDN (Content Delivery Network), video analytics etc.). Each of the different use cases and workloads have a different resources footprint. For instance, a CDN will utilize more Input/Output (I/O) allocated to NVME (Non-volatile Memory Express), more VNF (Virtual Network Function) I/O allocated to NIC (Network Interface Controller) and a larger Video Analytics compute+memory footprint relative to most other workloads. One of the approaches being considered today is to configure edge platforms in a balanced and general-purpose way so different types of workloads can achieve good performance regardless of configuration.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a diagram of a system illustrating overview of an OMP implementation, according to one embodiment;

FIG. 2a is a schematic diagram of a system including a smart device having virtual pooled memory logic, according to one embodiment

FIG. 2b is a variant of the system of FIG. 2a in which the other device memories comprise memory resources that are external to the smart device;

FIGS. 3a-3c show different views of a system including four smart devices coupled to a host, where FIG. 3a shows communication between the VPMLs on the smart devices and a pooled memory controller on the host; FIG. 3b shows communication between the VPMLs on the smart devices and a BMC; and FIG. 3c shows communication from the pooled memory controller to the smart devices;

FIG. 4 is a diagram illustrating aggregation of sub-ranges within the unallocated and allocated but currently unused ranges of memory;

FIG. 5 is a diagram of an exemplary SmartNIC card, according to one embodiment;

FIG. 6 is a diagram of an exemplary IPU card, according to one embodiment;

FIG. 7 is a schematic diagram of an AI compute system including 8 compute nodes coupled to an internal switch; and

FIG. 8 is a schematic diagram illustrating an embodiment of an edge appliance.

### DESCRIPTION OF THE INVENTION

Embodiments of methods and apparatus for opportunistic memory pools are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

One of the important challenges of the more general configuration (ideally the preferred one) is that Smart NICs, Infrastructure Processing Units (IPUs), Data Processing Units (DPUs), Accelerators and/or GPUs (Graphic Processing Units) may not be fully utilized when workloads being deployed in the platform are not network bound (i.e.: AI (Artificial Intelligence) video analytics or medium size CDN, etc.). In this case, the edge infrastructure is under-utilizing a significant percentage of memory and storage bandwidth that could otherwise be utilized for alternative or additional purposes.

Consider this case in a deployment including 4 NICs having access to 8 GB (Gigabyte) memory (each). If only 50% of the 8 GB of the memory from each of the 4 NICs is utilized, overall, the system is losing the opportunity to use 16 GB of memory. Hence, there may be a lot of memory across each of the devices lost due to fragmentation, which can account for significant resource losses in current deployments.

Embodiments of the solutions provided herein address resource fragmentation by extending the memory architecture with logic that divides and tracks the memory fragmentation in each of the discrete devices in two virtual memory partitions: (1) the allocated-unused partition containing memory that is earmarked for (allocated to), but remained un-utilized by the actual workloads running, or, by the device itself (bit-streams, applications, etc.); and (2) the unallocated partition that collects unused memory ranges and pushes them in to an Opportunistic Memory Pool (OMP) which is exposed to the main platform memory controller and operating system. The two partitions of the OMP allow temporary utilization of otherwise unused memory. Under alternate configurations, the total amount of memory resources is presented as a monolithic resource or two monolithic memory resources (unallocated and allocated unused) available for utilization by the devices and applications/services running in the platform. The platform memory controller and CPU are extended to recognize and manage memory resources added to the OMP. The OMP represents a new memory architecture that dynamically and opportunistically adjusts available memory by using intelligent monitoring of memory resources and workload utilization dynamics.

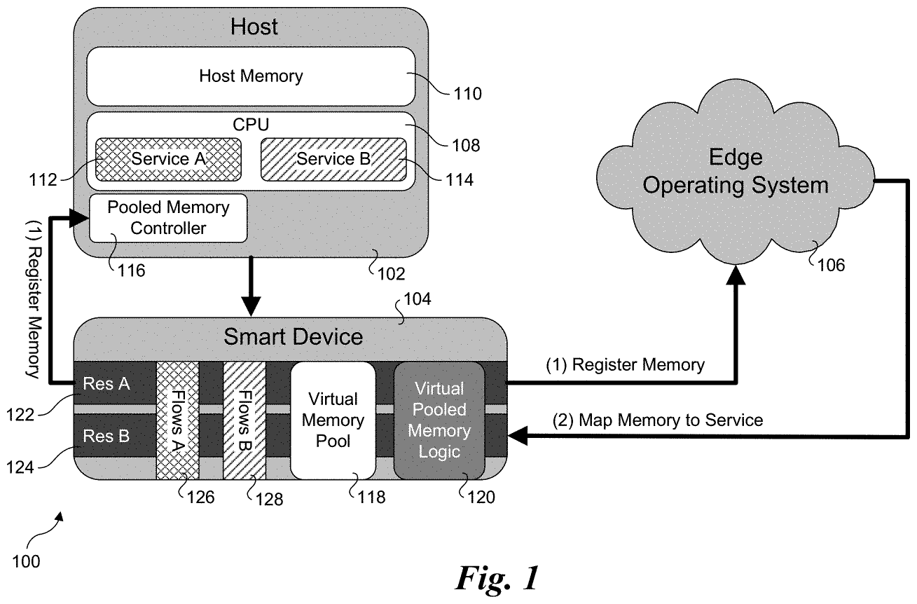

FIG. 1 shows system 100 illustrating overview of an OMP implementation, according to one embodiment. System 100 includes a host 102, a smart device 104, and an edge operating system 106. Host 102 includes a CPU (Central Processing Unit) 108 coupled to memory and executing software including services 112 and 114 (also labeled Service A and Service B). Host 102 further includes a pooled memory controller 116. Generally, CPU 108 and pooled memory controller may be separate components or may be integrated in a single chip or package, such as under a System on a Chip (SoC) architecture.

Smart device 104 is illustrative of a variety of “smart” devices, such as but not limited to a SmartNIC, an IPU, a DPU, a GPU or general-purpose GPU (GP-GPU) card, an accelerator device, etc. Smart device 104 includes one or more types of memory (not separately shown in FIG. 1) having a portion of which is used as a virtual memory pool 118, virtual pooled memory logic 120, resources used by services A and B (Res A 122 and Res B 124), and flows 126 and 128 (also labeled as Flows A and Flows B), respectively representing flows for Service A and Service B.

Virtual pooled memory logic (VPML) 120 includes monitoring logic that identifies the set of memory resources in smart device 104 that are unallocated according to a threshold function, and the expected configuration latency as defined by the device manufacturer or edge owner. This logic may optionally comprise hardware or software components that are dynamically loaded into a host application container, pod, etc., running in host memory 110 so that they can determine whether:
1. Memory is allocated (earmarked) but fails to be mapped-in or, has since been un-mapped and remains available for long durations on a free list; and
2. Memory is available in the device but remains unallocated by any host application container, pod, etc.

Virtual pooled memory logic 120 also include logic that physically or virtually removes the memory ranges identified by the monitoring logic from the main memory (aka host memory) and adds them into the OMP. Virtual pooled memory logic 120 also includes logic that connects to Edge Operating System 106, registers the new pooled memory range(s), and manages memory pool lifecycle.

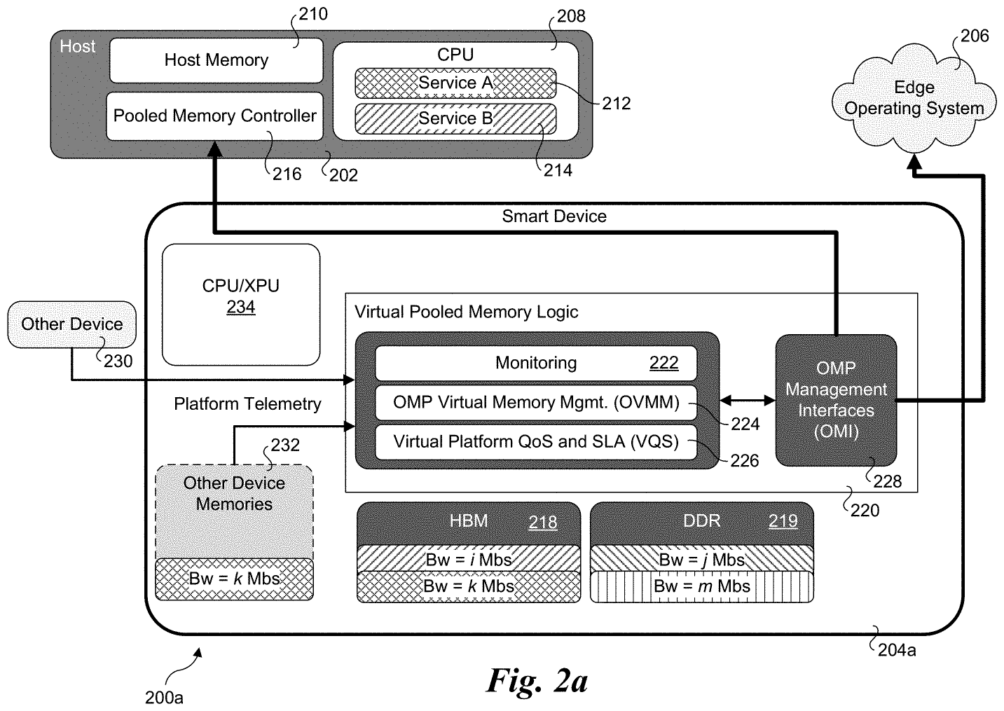

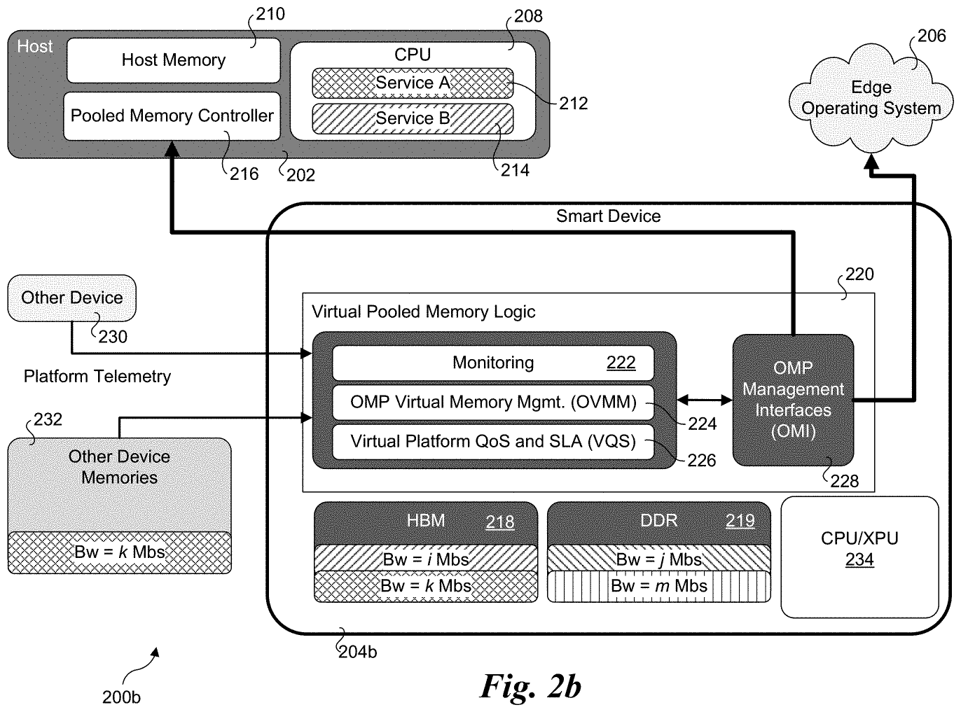

FIG. 2a shows a system 200a providing further details of a smart device 204a, according to one embodiment. System 200a includes a host 202, smart device 204a, and edge operating system 206. Host 202 is configured similar to host 102 in FIG. 1, and includes a CPU 208 coupled to host memory 210, and running services 212 and 214 (also labeled “Service A” and “Service B”), and a pooled memory controller 216.

Smart device 204a includes one or more types of memory, depicted as high bandwidth memory (HBM) 218 and Double Data-Rate (DDR) memory 219. Smart device 204 includes virtual pooled memory logic 220 which includes monitoring logic 222, OMP Virtual Memory Management (OVMM) logic 224, and virtual platform QoS and SLA (Service Level Agreement) (VQS) logic 226. Virtual pooled memory logic 220 also includes OMP Management Interface Interfaces (OMI) 228, which provides an interface to pooled memory controller 216 and edge operating system 206.

As further shown in FIG. 2a, virtual pooled memory logic 220 receives platform telemetry information from other device 230 and other device memories 232. Generally, other device 230 is illustrative of one or more other devices in the platform, such as peripheral devices that connect via USB, SATA, Ethernet, wireless, etc., and provide a service to the platform/host. This may include devices such as a Baseboard Management Controller (BMC), a Storage Area Network (SAN) controller, GPU, or AI Card. Other device memories 232 represent other memory devices that may be on-board smart device 204a or may comprise an external memory or memory device that can be accessed via an interconnect or the like, such as a Compute Express Link (CXL) connected memory/storage, an NVME memory device, or a PCIe connected memory controller. An example of a smart device 200b in a system 200b with other device memories 232 comprising external memory is shown in FIG. 2b.

A monitoring logic 222 is responsible for identifying that a set of memory resources of smart device 204 that could compose a new set of memory ranges that are not being utilized for a certain amount of time. In one embodiment, monitoring logic 222 provides a set of interfaces to configure the logic including a configuration interface that allows specifying per each of the resources minimum amount of memory required by the main platform to be useful enough (i.e., >10 MB), and a configuration interface that allows specifying thresholds (in terms of temporal units—e.g., seconds) that indicate for how long memory ranges need not be utilized before moving them from available into the smart device to the smart OMP. Monitoring logic 222 also includes telemetry monitoring logic that is responsible for processing telemetry data coming from the various memory resources on the smart device and deciding (using the set of interfaces to configure the logic) where to move certain memory regions outside to the main OMP pool.

As shown by CPU/XPU 234, smart device 204a also includes one or more processors, such as a CPU or Other Processing Unit. Other Processing Units (collectively termed XPUs) include one or more of GPUs or GP-GPUs, Tensor Processing Units (TPUs), DPUs, IPUs, Artificial Intelligence (AI) processors or AI inference units and/or other accelerators, Field Programmable Gate Arrays (FPGAs) and/or other programmable logic (used for compute purposes), etc. While some of the diagrams herein show the use of CPUs, this is merely exemplary and non-limiting. Generally, any type of XPU may be used in place of a CPU in the illustrated embodiments. Moreover, as used in the following claims, the term “processor” is used to generically cover CPUs and various forms of XPUs.

Virtual pooled memory logic 220 also includes logic that is responsible for physically and/or virtually removing the set of memory ranges identified by monitoring logic 222 from the smart device utilized by the platform services (e.g., Services/Processes A and B in the FIG. 2a), create a new virtual memory and push it to the smart OMP.

Generally, the on-board memory or memories and external memories may comprise one or more types of memory, including but not limited to the lists below. For illustrative purposes, HBM memory 218, DDR memory 219 and other devices memories 232 are depicted to have Bandwidths (Bw) of i, j, k, and m Mbs (megabits per second), where i, j, k, and m represent different numerical (integer) values. The actual bandwidths of the memories may differ based on a variety of considerations, including but not limited to memory type, workload, memory interconnect/link, and access protocol.

OMP Virtual Memory Management (OVMM) logic 224 is responsible for binding a set of resources from the virtual platform pool (moved from the smart device pool of resources by the telemetry monitoring logic) and exposing them to both the platform memory controller and the operating system. In one embodiment two memory resource binding options are considered:
1. Proactively create the memory ranges once there are enough resources to be created. In this case, this logic may have a set of platform flavors (e.g.: flavor 1=2 cores, 2 GB of HBM and 4 GB of DDR; flavor 2= . . . ).
2. Wait until an orchestrator requires creation of a new set of virtual ranges. In this case, the logic will create (if possible) the actual virtual memory ranges depending on the resource requirements from the orchestrator.

Virtual Platform QoS and SLA (VQS) management logic 226 is responsible for monitoring both virtual platforms and services running on the main platform (host) have the QoS and SLA that has been requested by the orchestrator to the pooled memory. This is mainly designed for those resources which cannot be physically partitioned or for those resources where SLA can be enforced (such as memory using type of leaky bucket—RDT) but it's preferable not to (unless an SLA is violated)

OMP Management Interface (OMI) 228 is responsible for connecting the virtual platform to the edge orchestrator, registering the new virtual platform and managing its lifecycle. In one embodiment, lifecycle management may involve the following capabilities:
1. One or more out of band (OOB) interfaces (e.g., available to a BMC or the like) to configure whatever knobs can be configured from the platform (Quality of Service (QoS), security, etc.);
2. One or more OOB interfaces to discover the specific memory ranges and their characteristics within the virtual memory pool; and
3. A mechanism to register a bit-stream or application to perform memory operations over the set the new memory ranges (e.g., zeroing, or any other type of function).

Existing techniques such as paging can be used in some scenarios where memory is recalled from the device. However, these scenarios are expected to happen in large granularities sufficient for it to pay off.

Also, given the OMP may contain memory fragments from a variety of different memory types, the Key Performance Indicator (KPI) properties may vary. The OMP logic may include arranging the pool according to similar KPI properties so that there is a spectrum of or bucketization of pools of memory based on KPI. The system memory allocator might be modified to reflect KPI properties generally. For example, Linux malloc( ) might include a KPI parameter that allows allocations according to memory speed (read, write, read-write, etc.).

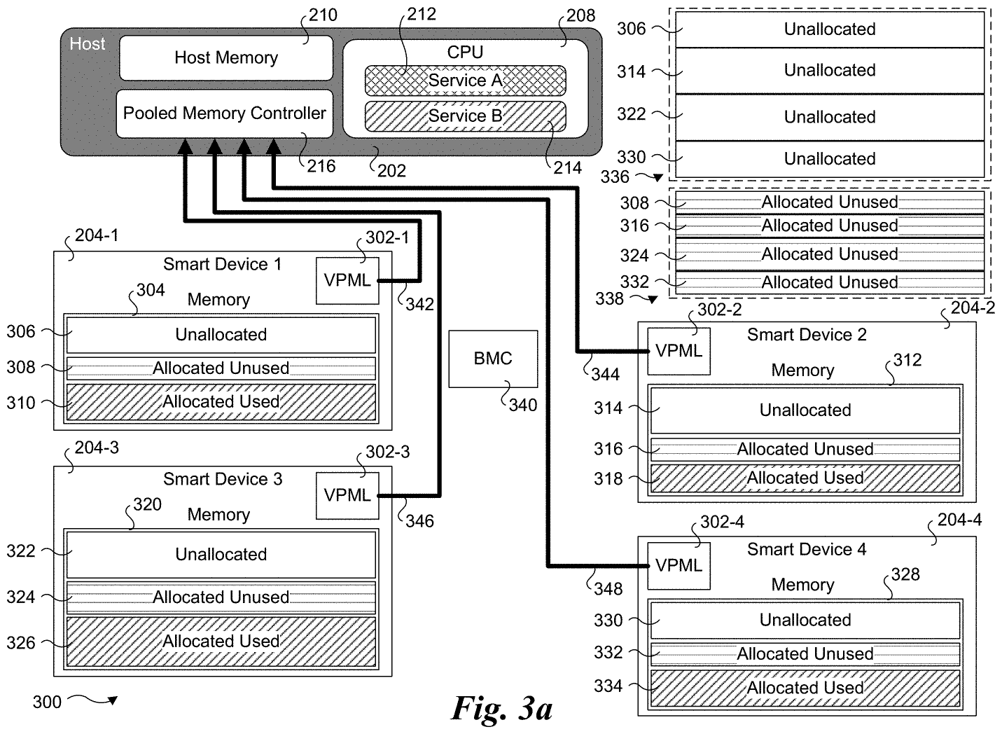

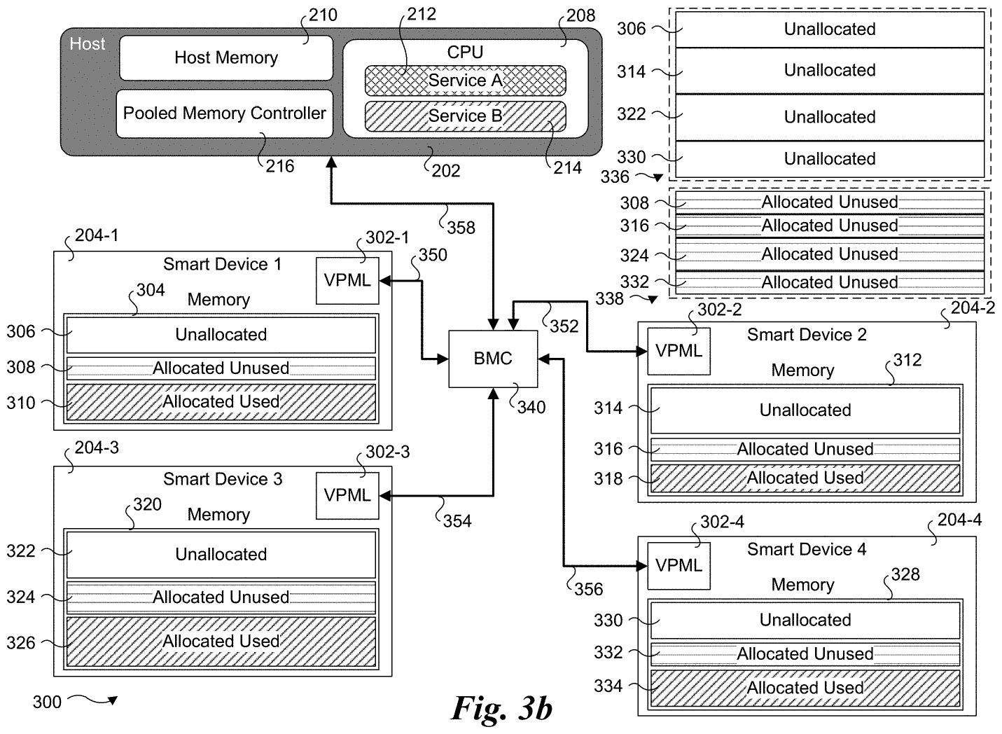

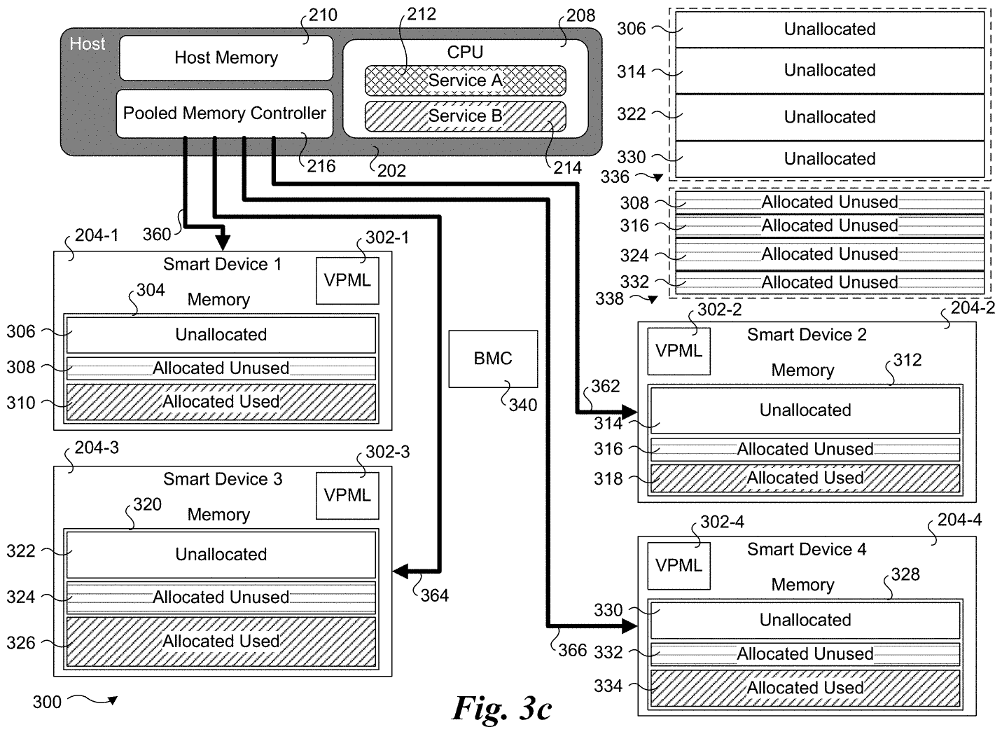

FIGS. 3a-3c show respective views of a system 300 including four smart devices 204-1, 204-2, 204-3, and 204-4 (also labeled Smart Device 1, 2, 3, and 4) coupled to a host 202 having a configuration like that shown in FIGS. 2a and 2b. Each of smart devices 204-1, 204-2, 204-3, and 204-4 includes a respective VPML 302-1, 302-2, 302-3, and 304-4. System 300 also includes a BMC 340.

Smart device 204-1 has memory 304 including unallocated memory 306, allocated but unused memory 308, and allocated and used memory 310. Smart device 204-2 has memory 312 including unallocated memory 314, allocated but unused memory 316, and allocated and used memory 318. Smart device 204-3 has memory 320 including unallocated memory 322, allocated but unused memory 324, and allocated and used memory 326. Smart device 204-1 has memory 328 including unallocated memory 330, allocated but unused memory 332, and allocated and used memory 334.

As discussed above, under aspects of the solution unallocated memory is aggregated and presented as one or more pooled memory resources, as shown by a pooled unallocated memory resource 336 which comprises unallocated memories 306, 314, 322 and 330. A similar scheme is applied to allocated but currently unused memories, as depicted by a pooled allocated unused memory resource 338 comprising allocated unused memories 308, 316, 324, and 332. Under one scheme, pooled unallocated memory resource 336 and pooled allocated unused memory resource 338 are presented as separate pooled memory resources to services running on the host and workloads running on the smart devices. Under another scheme, the pooled unallocated memory resource 336 and pooled allocated unused memory resource 338 are aggregated into a monolithic pooled memory resource that is presented to services running on the host and workloads running on the smart devices.

As further shown in FIG. 3a, VPMLs 302-1, 302-2, 302-3, and 302-4 are coupled in communication with pooled memory controller 216 via respective links 342, 344, 346, and 348. Generally, links 342, 344, 346, and 348 may comprise in-band or out-of-band (OOB) links. Examples of in-band links include PCIe links and CXL links, noting the latter uses PCIe link structures. Out-of-band links may employ a sideband channel or the like.

As shown in FIG. 3b, BMC 340 is connected to each of VPML 302-1, 302-2, 302-3 and 302-4 via respective links 350, 352, 354, and 356. BMC 340 is also connected to host 202 via a link 358. In one embodiment, links 350, 352, 354, 356, and 358 are OOB links.

FIG. 3c shows pooled memory controller 216 connected to each of smart devices 204-1, 204-2, 204-3, and 204-4 via respective links 360, 362, 364, and 366. In alternative embodiments, these links comprise PCIe links or CXL links.

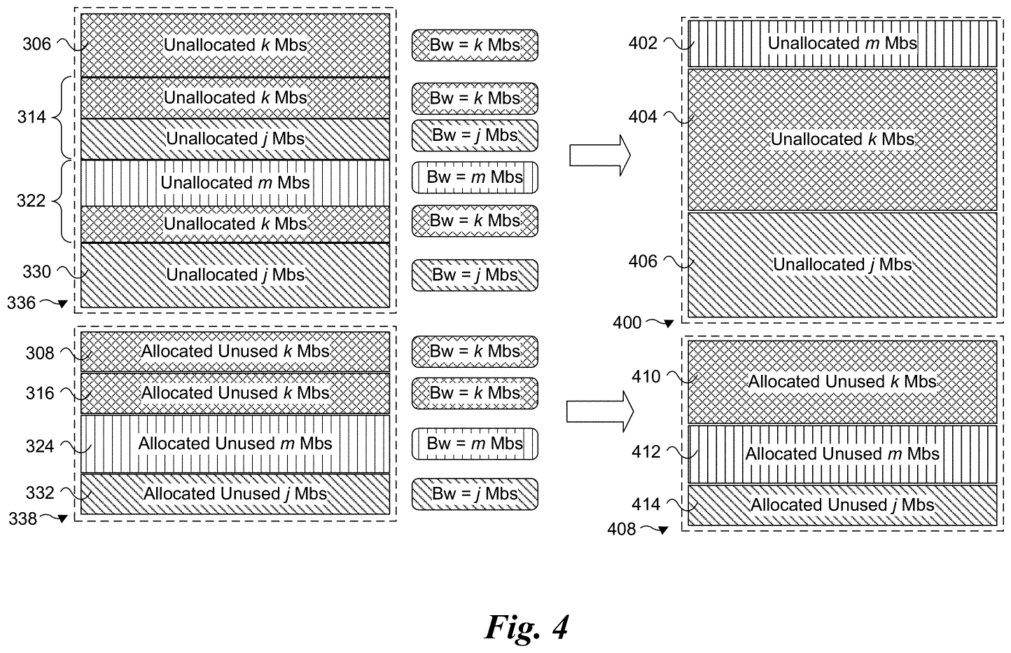

As shown in FIG. 4, the bandwidth of allocated unused and an unallocated memory may differ on different smart devices and/or on the same smart device. In the pooled unallocated memory resource presented by the operating system, the ranges of allocated memory 400 are aggregated by bandwidth, as depicted by ranges 402, 404, and 406. Likewise, in the pooled allocated unused memory resource presented by the operating system, the ranges of unallocated unused memory 408 are aggregated by bandwidth, as depicted by ranges 410, 412, and 414.

Bandwidth is one type of KPI that may be used. Pooled memory resources of smart device memory may also use other types of KPI, such as type of memory (e.g., volatile DDR DRAM, non-volatile RAM (NVRAM), storage class memory (SCM), HBM, Graphics memory, etc.) or access protocol (e.g., PCIe, CXL, NVMe). KPI may also comprise a combination of the foregoing, such as bandwidth+type of memory, type of memory+access protocol, bandwidth+access protocol, etc.

Example Smart Devices

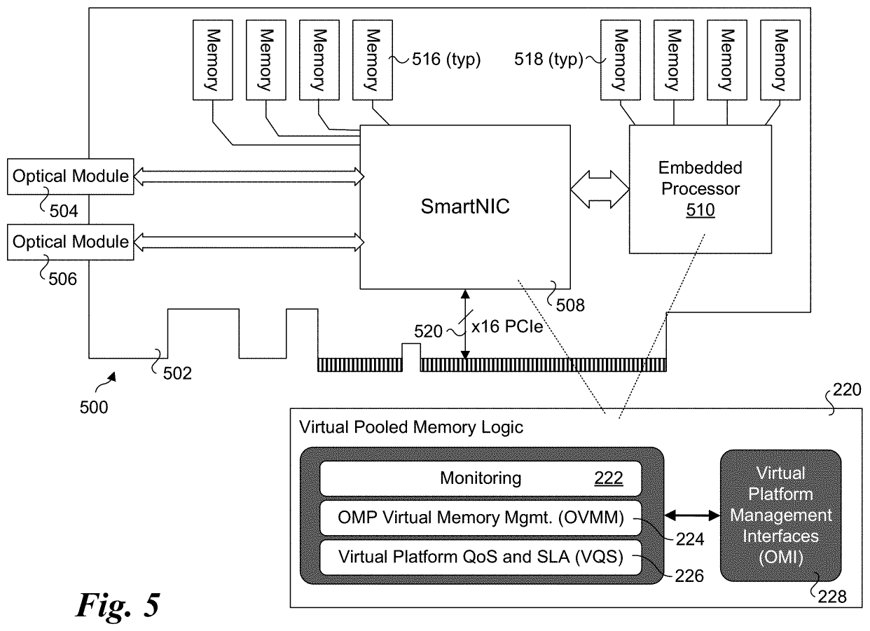

FIG. 5 shows a SmartNIC 500 comprising a PCIe card including a circuit board 502 having a PCIe edge connector and to which various integrated circuit (IC) chips and components are mounted, including optical modules 504 and 506. The IC chips include a SmartNIC chip 508, an embedded processor 510 and memory (e.g., DDR5, DDR5, LPDDR5 DRAM, HBM) chips 516 and 518. SmartNIC chip 508 is a multi-port Ethernet NIC that is configured to perform various Ethernet NIC functions, as is known in the art. In some embodiments, SmartNIC chip 508 is an FPGA and/or includes FPGA circuitry.

Generally, SmartNIC chip 508 may include embedded logic for performing various packet processing operations, such as but not limited to packet classification, flow control, RDMA (Remote Direct Memory Access) operations, an Access Gateway Function (AGF), Virtual Network Functions (VNFs), a User Plane Function (UPF), and other functions. In addition, various functionality may be implemented by programming SmartNIC chip 508, via pre-programmed logic in SmartNIC chip 508, via execution of firmware/software on embedded processor 510, or a combination of the foregoing. The various functions and logic in the embodiments of VPML 220 described and illustrated herein may be implemented by programmed logic in SmartNIC chip 508 or and/or execution of software on embedded processor 500.

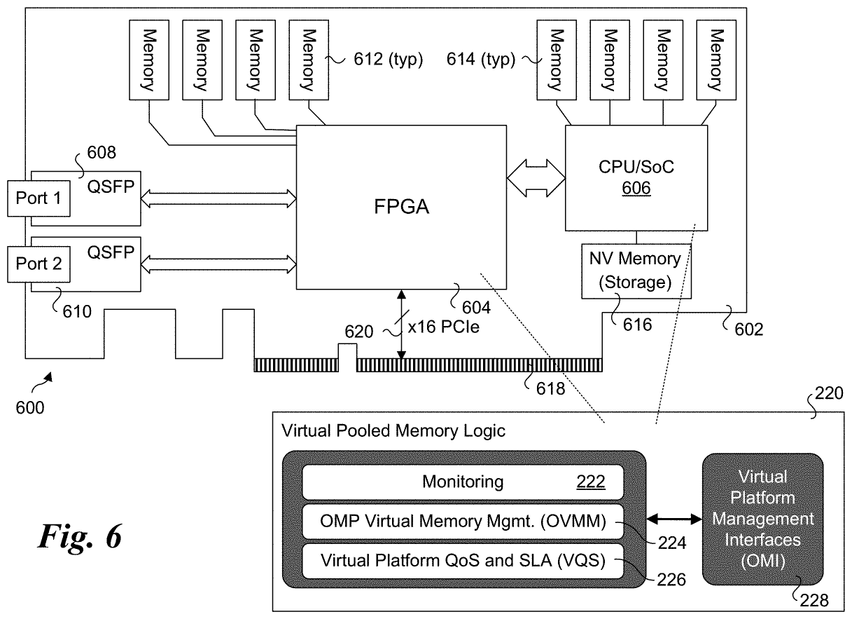

FIG. 6 shows one embodiment of IPU 600 comprising a PCIe card including a circuit board 602 having a PCIe edge connector to which various integrated circuit (IC) chips and modules are mounted. The IC chips and modules include an FPGA 604, a CPU/SOC 606, a pair of QSFP (Quad Small Form factor Pluggable) modules 608 and 610, memory (e.g., DDR5, DDR5, LPDDR5, HBM DRAM) chips 612 and 614, and non-volatile memory 616 used for local persistent storage. FPGA 604 includes a PCIe interface (not shown) connected to a PCIe edge connector 618 via a PCIe interconnect 620 which in this example is 16 lanes. The various functions and logic in the embodiments of VPML 220 described and illustrated herein may be implemented by programmed logic in FPGA 604 and/or execution of software on CPU/SOC 606. FPGA 604 may include logic that is pre-programmed (e.g., by a manufacturing) and/or logic that is programmed in the field (e.g., using FPGA bitstreams and the like). For example, logic in FPGA 604 may be programmed by a host CPU for a platform in which IPU 600 is installed. IPU 600 may also include other interfaces (not shown) that may be used to program logic in FPGA 604. In place of QSFP modules 608, wired network modules may be provided, such as wired Ethernet modules (not shown).

CPU/SOC 606 employs a System on a Chip including multiple processor cores. Various CPU/processor architectures may be used, including but not limited to x86, ARM®, and RISC architectures. In one non-limiting example, CPU/SOC 606 comprises an Intel® Xeon®-D processor. Software executed on the processor cores may be loaded into memory 614, either from a storage device (not shown) for a host, or received over a network coupled to QSFP module 608 or QSFP module 610.

Generally, an IPU and a DPU are similar, whereas the term IPU is used by some vendors and DPU is used by others. A SmartNIC is similar to an IPU/DPU except it will generally be less powerful (in terms of CPU/SoC and size of the FPGA). As with IPU/DPU cards, the various functions and logic in the embodiments described and illustrated herein may be implemented by programmed logic in an FPGA on the SmartNIC and/or execution of software on CPU or processor on the SmartNIC. In addition to the blocks shown, an IPU or SmartNIC may have additional circuitry, such as one or more embedded ASICs that are preprogrammed to perform one or more functions related to packet processing.

Example Systems and Appliances

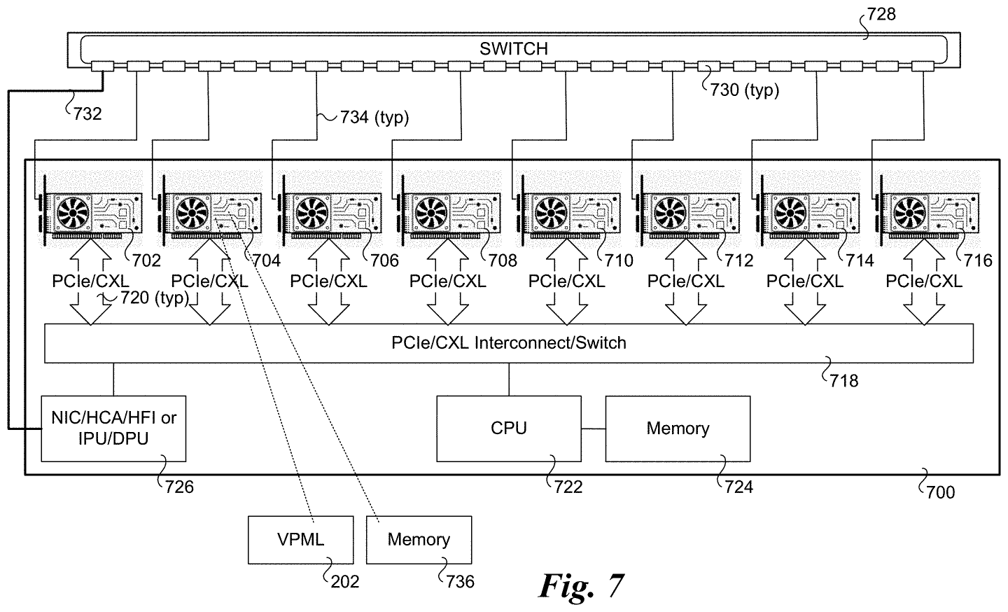

FIG. 7 shows an AI system 700 including 8 compute nodes 702, 704, 706, 708, 710, 712, 714, and 716. In the illustrated example, each of these compute nodes comprise a GPU card that includes one or more GPUs (or GP-GPUs) and on-board memory (e.g., 4+GB of memory). Optionally, the GPUs may be implemented on other form factors, such as mounted to a main board or on daughterboards or the like. The compute nodes 702, 704, 706, 708, 710, 712, 714, and 716 are coupled to a PCIe or CXL interconnect/switch 718. For some embodiments PCIe or CXL interconnect/switch 718 will comprises a plurality of expansion slots in which respective GPU cards are installed. AI system 700 also includes a CPU 722, memory 724, and an NIC/HCA (Host Channel Adapter)/HFI (Host Fabric Interface) or IPU/DPU 726, which may be any of an Ethernet NIC, InfiniBand HCA, Host Fabric Interface, or an IPU or DPU.

Generally, AI system 700 may be housed in a cabinet or chassis that is installed in a rack (not separately shown). Also installed in the rack is a ToR switch 728 including a plurality of ports 730. One or more ports for NIC/HCA/HFI or IPU/DPU 726 are coupled via respective links (one of which is shown) to a port on ToR switch 728. As an option, each of compute nodes 702, 704, 706, 708, 710, 712, 714, and 716 includes an applicable network or fabric interface that is coupled to a respective port 730 on ToR switch 728 via a respective link 734. As further shown in FIG. 7, each of compute nodes 702, 704, 706, 708, 710, 712, 714, and 716 includes an instance of VPML 202 and one or more types of memory 736.

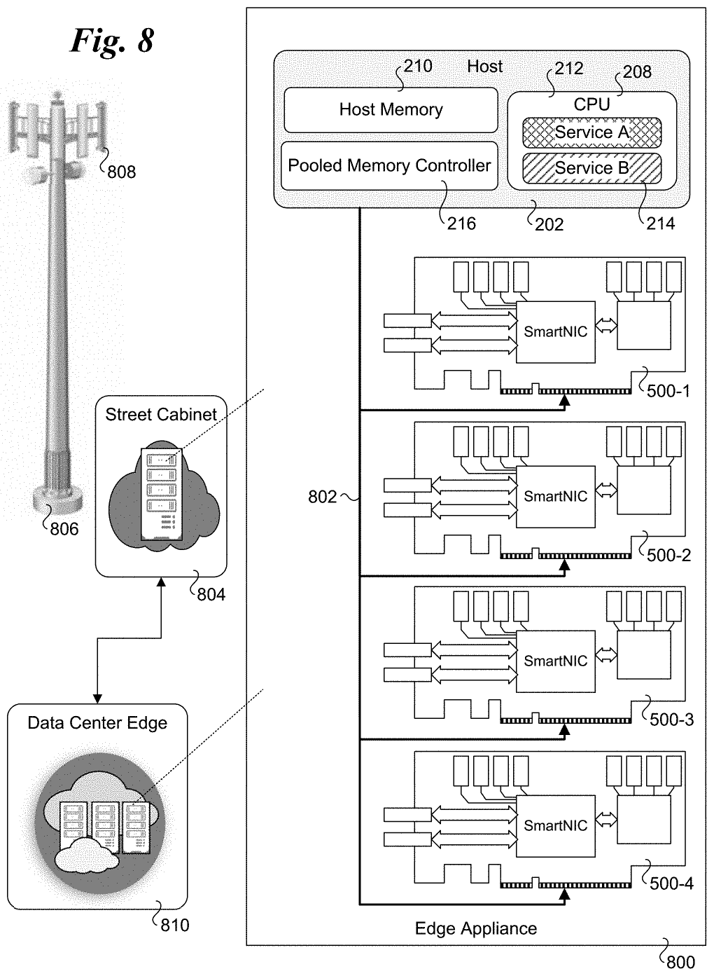

FIG. 8 shows an example of an edge appliance 800 that may be configured to implement aspects of the foregoing embodiments. In the illustrated example, edge appliance 800 includes four SmartNICs 500-1, 500-2, 500-3, and 500-4 coupled to a host 202 via a PCIe bus 802. For example, the main board for edge appliance 800 may include multiple PCIe slots in which respective SmartNICs 500-1, 500-2, 500-3, and 500-4 are installed. Each of the SmartNICs has a configuration similar to SmartNIC 500 shown in FIG. 5 including an instance of VPML 220 (not separately shown in FIG. 8).

Edge appliance 800 may be implemented at various locations, including in a street cabinet 804 at the base of a cellular tower 806 including an antenna 808 or at a data center edge 810. When located in a street cabinet, edge appliance 800 may be configured to perform Radio Access Network (RAN) processing operations associated with signals received at antenna 808. In another configuration, one or more of the SmartNICs is replaced with an IPU or DPU card.

Generally, the memories depicted herein may comprise one of more of volatile memory and non-volatile memory. Volatile memory is memory whose state (and therefore the data stored in it) is indeterminate if power is interrupted to the device. Dynamic volatile memory requires refreshing the data stored in the device to maintain state. One example of dynamic volatile memory incudes DRAM (Dynamic Random Access Memory), or some variant such as Synchronous DRAM (SDRAM). A memory subsystem as described herein can be compatible with a number of memory technologies, such as DDR4 (Double Data Rate version 4, initial specification published in September 2012 by JEDEC (Joint Electronic Device Engineering Council)). DDR4E (DDR version 4), LPDDR3 (Low Power DDR version3, JESD209-3B, August 2013 by JEDEC), LPDDR4 (LPDDR version 4, JESD209-4, originally published by JEDEC in August 2014), WIO2 (Wide Input/Output version 2, JESD229-2 originally published by JEDEC in August 2014), HBM (High Bandwidth Memory, JESD325, originally published by JEDEC in October 2013), DDR5 (DDR version 5, JESD79-5A, published October, 2021), DDR version 6 (currently under draft development), LPDDR5, HBM2E, HBM3, and HBM-PIM, or others or combinations of memory technologies, and technologies based on derivatives or extensions of such specifications. The JEDEC standards are available at www.jedec.org.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Tri-Level Cell (“TLC”), Quad-Level Cell (“QLC”), Penta-Level Cell (PLC) or some other NAND). A NVM device can also include a byte-addressable write-in-place three dimensional crosspoint memory device, or other byte addressable write-in-place NVM devices (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Italicized letters, such as ‘i’, ‘j’, ‘k’, “m’, etc. in the foregoing detailed description are used to depict an integer number, and the use of a particular letter is not limited to particular embodiments. Moreover, the same letter may be used in separate claims to represent separate integer numbers, or different letters may be used. In addition, use of a particular letter in the detailed description may or may not match the letter used in a claim that pertains to the same subject matter in the detailed description.

As discussed above, various aspects of the embodiments herein may be facilitated by corresponding software and/or firmware components and applications, such as software and/or firmware executed by an embedded processor or the like. Thus, embodiments of this invention may be used as or to support a software program, software modules, firmware, and/or distributed software executed upon some form of processor, processing core or embedded logic a virtual machine running on a processor or core or otherwise implemented or realized upon or within a non-transitory computer-readable or machine-readable storage medium. A non-transitory computer-readable or machine-readable storage medium includes any mechanism for storing or transmitting information in a form readable by a machine (e.g., a computer). For example, a non-transitory computer-readable or machine-readable storage medium includes any mechanism that provides (i.e., stores and/or transmits) information in a form accessible by a computer or computing machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A non-transitory computer-readable or machine-readable storage medium may also include a storage or database from which content can be downloaded. The non-transitory computer-readable or machine-readable storage medium may also include a device or product having content stored thereon at a time of sale or delivery. Thus, delivering a device with stored content, or offering content for download over a communication medium may be understood as providing an article of manufacture comprising a non-transitory computer-readable or machine-readable storage medium with such content described herein.

The operations and functions performed by various components described herein may be implemented by software running on a processing element, via embedded hardware or the like, or any combination of hardware and software. Such components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration information, etc.) may be provided via an article of manufacture including non-transitory computer-readable or machine-readable storage medium, which provides content that represents instructions that can be executed. The content may result in a computer performing various functions/operations described herein.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. An apparatus, configured to communicate with a host running one or more services:
one or more one processors,
associated memory comprising one or more memory resources operatively coupled to the one or more processors; and
virtual pooled memory logic to:
identify a first range of memory that has been allocated for at least one of the one or more services and is currently unused;
identify a second range of memory that is unallocated;
provide one or more properties for the first range of memory and the second range of memory to the host.

2. The apparatus of claim 1, wherein the virtual pooled memory logic includes an interface to provide the one or more properties for first range of memory and the second range of memory to a pooled memory controller on the host.

3. The apparatus of claim 1, wherein the virtual pooled memory logic includes an interface to provide the one or more properties for the first range of memory and the second range of memory to an operating system running on the host.

4. The apparatus of claim 1, wherein the apparatus comprises a network interface controller (NIC).

5. The apparatus of claim 1, wherein the apparatus comprises an infrastructure processing unit (IPU) or a data processing unit (DPU).

6. The apparatus of claim 1, wherein the one or more processors comprise at least one of a Graphic Processor Unit (GPU), a General Purpose GPU (GP-GPU), a Tensor Processing Unit (TPU), a Data Processing Unit (DPU), and Infrastructure Processing Unit (IPU), an Artificial Intelligence (AI) processor, an AI inference unit, and a Field Programmable Gate Array (FPGA).

7. The apparatus of claim 1, wherein the virtual pooled memory logic is further to identify, for at least one of the first and second ranges of memory:
at least one Key Performance Indicator (KPI) property of a first sub-range of the range of memory; and
at least one KPI property of a second sub-range of the range of memory; and
wherein the apparatus is further configured to provide the one or more KPI properties for each of the first sub-range and second sub-range of the range of memory to the host.

8. The apparatus of claim 1, wherein the one or more properties for at least one of the first and second ranges of memory comprises start and end addresses associated with each range and one or more of:
a bandwidth for the range;
a memory type for the range; and
an access protocol for the range.

9. The apparatus of claim 1, wherein the apparatus includes a card having on-board memory to which external memory is coupled, and wherein the associated memory comprises the on-board memory and the external memory.

10. The apparatus of claim 1, wherein the virtual pooled memory logic is further to receive telemetry data from at least one external device.

11. An apparatus comprising:
a host including one or more processors coupled to host memory and having a pooled memory controller, the host having an operating system and configured to run one or more services on the one or more processors; and
a plurality of smart devices, each having one or more processors and associated memory including at least one of on-board memory and external memory coupled to the smart device, wherein each of the smart devices is configured to,
identify a first range of its associated memory that has been allocated for at least one of the one or more services and is currently unused;
identify a second range of its associated memory that is unallocated; and
provide one or more properties associated for the first range of memory and the second range of memory to the host.

12. The apparatus of claim 11, wherein the one or more properties for the first range and second range of memory received from each smart devices includes start and end addresses of the first range and second ranges of memory, and wherein the host is configured to:
aggregate sizes of the first ranges of memory;
aggregate sizes of the second ranges of memory; and
present a monolithic pooled memory resource comprising the aggregated sizes of the first and second ranges of memory.

13. The apparatus of claim 12, wherein the apparatus is configured to enable allocation of memory in the monolithic pooled memory resource to at least one of services running on the host and workloads running on the smart devices.

14. The apparatus of claim 11, wherein the one or more properties for the first range and second range of memory received from each smart devices includes sizes of the first range and second ranges of memory, and wherein the host is configured to:
aggregate sizes of the first ranges of memory and presenting the aggregated size as a first pooled memory resource comprising allocated and currently unused memory available to services running on the host; and
aggregate sizes of the second ranges of memory and presenting the aggregated size as a second pooled memory resource comprising unallocated memory available to services running on the host.

15. The apparatus of claim 11, wherein at least one smart device is configured to identify, for at least one of the first and second ranges of its associated memory:
at least one Key Performance Indicator (KPI) property of a first sub-range of the range of memory; and
at least one property of a second sub-range of the range of memory; and
wherein the one or more properties for the first range of memory and the second range of memory provided to the host include the one or more KPI properties for each of the first sub-range and second sub-range of the range of memory.

16. A method implemented in an apparatus including a host having one or more processors coupled to host memory and having a pooled memory controller, the host having an operating system and configured to run one or more services on the one or more processors, the system further having a plurality of smart devices, each having one or more processors and associated memory including at least one of on-board memory and external memory coupled to the smart device, the method comprising:
for each of the smart devices,
identifying a first range of its associated memory that has been allocated for at least one of the one or more services and is currently unused;
identifying a second range of its associated memory that is unallocated; and
providing one or more properties for the first range of memory and the second range of memory to the host.

17. The method of claim 16, wherein the one or more properties for the first range and second range of memory received from each smart devices includes start and end addresses of the first range and second ranges of memory, further comprising:
aggregating the first ranges of memory;
aggregating the second ranges of memory; and
presenting a monolithic pooled memory resource comprising the aggregated first and second ranges of memory.

18. The apparatus of claim 17, further comprising enabling allocation of memory in the monolithic pooled memory resource to at least one of services running on the host and workloads running on the smart devices.

19. The method of claim 16, wherein the one or more properties for the first range and second range of memory received from each smart devices includes sizes of the first range and second ranges of memory, further comprising:
aggregating sizes of the first ranges of memory and presenting the aggregated size as a first pooled memory resource comprising allocated and currently unused memory available to services running on the host; and
aggregating sizes of the second ranges of memory and presenting the aggregated size as a second pooled memory resource comprising unallocated memory available to services running on the host.

20. The method of claim 16, further comprising identifying, for at least one of the first and second ranges of the associated memory for a smart device:
at least one Key Performance Indicator (KPI) property of a first sub-range of the range of memory; and
at least one property of a second sub-range of the range of memory; and
wherein the one or more properties for the first range of memory and the second range of memory provided to the host include the one or more KPI properties for each of the first sub-range and second sub-range of the range of memory.
